(19) United States
(12) Patent Application Publication
(10) Pub. No.: US 2017/0107329 A1
(43) Pub. Date: Apr. 20, 2017

(54) HEAT-TREATED FINE POLYARYLENE SULFIDE POWDER AND MANUFACTURING METHOD FOR MANUFACTURING SAME

(71) Applicant: Kureha Corporation, Tokyo (JP)

(72) Inventors: Akihiro KONNO, Tokyo (JP); Takuya OHZAWA, Tokyo (JP); Hirohito KAWAMA, Tokyo (JP)

(21) Appl. No.: 15/128,736

(22) PCT Filed: Mar. 25, 2015
(86) PCT No.: PCT/JP2015/059217

§ 371 Date: Sep. 23, 2016

(30) Foreign Application Priority Data
Mar. 25, 2014 (JP) 2014-062259

(51) Int. Cl. C08G 75/0277; C08G 75/0281; C08G 75/0254; C08G 75/0213

(52) U.S. Cl. CPC C08G 75/0277; C08G 75/0213; C08G 75/0281; C08G 75/0254

(57) ABSTRACT

A heat treated fine polyarylene sulfide powder. (i) The heat treated fine polyarylene sulfide powder is manufactured from separation liquid. (ii) The heat treated fine polyarylene sulfide powder is obtained by subjecting the separation liquid to solid-liquid separation to obtain a raw material fine powder polyarylene sulfide. Thereafter the raw material fine powder polyarylene sulfide is subjected to pre-heat treatment and heat treatment. (iii) The heat treated fine polyarylene sulfide powder has an average particle size of from 1 to 80 μm. (iv) The heat treated fine polyarylene sulfide powder has a melt viscosity of 1 Pa·s or greater. (v) A generated gas amount of the heat treated fine polyarylene sulfide is 10 ppm or less.

### TECHNICAL FIELD

The present invention relates to a heat treated fine polyarylene sulfide powder, manufactured from a separation liquid produced in a separation step during a manufacturing method for granular polyarylene sulfide, the manufacturing method including a polymerization step and the separation step, and a manufacturing method for the heat treated fine polyarylene sulfide powder.

### BACKGROUND ART

Polyarylene sulfide (hereinafter sometimes referred to as “PAS”), typified by polyphenylene sulfide (hereinafter sometimes referred to as “PPS”) is an engineering plastic with excellent heat resistance, chemical resistance, flame retardancy, mechanical strength, electrical characteristics, dimensional stability and other properties. PAS is widely used in a range of technical fields including those of electrical instruments, electronic instruments, automobile instruments and packaging materials, due to its ability to be formed into various molded products, films, sheet, fibers, and the like by being subjected to general melting processing methods such as extrusion molding, injection molding and compression molding.

A typical manufacturing method for PAS is to cause a polymerization reaction under heated conditions to a paradichlorobenzene (hereinafter sometimes referred to as “pDCB”) or other dihalo aromatic compound (hereinafter sometimes referred to as “DHA”) and a sulfur compound such as alkali metal sulfide or alkali metal hydrosulfide as the sulfur source, in an organic amide solvent such as N-methyl-2-pyrrolidone (hereinafter sometimes referred to as “NMP”), and subsequently separating PAS from the PAS-containing reaction solution thereby obtained and recovering it by washing and drying.

This polymerization reaction is a desalting polycondensation reaction, wherein, in addition to the reactant PAS, by-product alkali metal salts such as for example, alkali metal halides (for example, NaCl), dimers, trimers and other low polymers, and impurities (volatile substances and substances with a high boiling point, and the like) are also produced. For this reason, subsequent to the polymerization reaction, these organic amide solvents, byproduct alkali metal salts, low polymers, and impurities may be present either between or inside PAS particles, or in the reaction solution. Accordingly, PAS separated from the PAS-containing reaction solution is sufficiently washed in order to remove the organic amide solvent, byproduct alkali metal salts, low polymers, and impurities before being recovered, thereby improving quality maintenance of the PAS used as product.

At the same time, the separation liquid from which PAS was separated using solid-liquid separation of the PAS-containing reaction solution, contains microscopic particulate form PAS (hereinafter sometimes referred to as “raw material fine PAS powder”). However, this raw material fine PAS powder is not as good as the product PAS from a quality perspective (molecular weight, color, smell, gas generation, and the like), and as a result it is not recovered to be made into product, but is disposed of. The disposal of raw material fine PAS powder is done by solid-liquid separation using filtration, and the like of the separation liquid, in order to comply with environmental criteria during disposal, allowing the recovery of raw material fine PAS powder, after which if necessary the organic amide solvent, byproduct alkali metal salts, low polymers, and impurities are removed from between and in the fine particles of raw material fine PAS powder by washing, and disposal is implemented after confirming compliance with environmental criteria (for example, landfill or incineration).

Furthermore, even if raw material fine PAS powder is productized, since the quantity of product obtained is small, it has no value in industrial use, and causes few problems if disposed of (hereinafter, where raw material fine PAS powder is recovered and productized, the quantity obtained is sometimes referred to as the “product rate”).

However, around 30 years have now passed since PAS first entered the market, and along with demands for quality, the market also has also come to demand cost reductions, and these demands are becoming stronger each year. For that reason, there has been a general review of the steps by which PAS is manufactured.

Against this background, from the perspectives of reducing PAS costs and responding to environmental problems, consideration has been ongoing of the recovery as a product of raw material fine PAS powder that would conventionally have been disposed of, by collection from separation liquid.

In Patent Document 1, specifically, a method is proposed in which, after polymerization for 3. 0 hours at a reaction temperature of 260° C., particulate polymer is separated using a 60 mesh screen, and NaCl is removed from the separation liquid, after which the mixed liquid, containing PAS oligomer and solvent has water added to it, and after the oligomer has been coagulated it is centrifugally separated to separate the PAS oligomer.

In this case, 60 mesh has an aperture of 250 μm, so oligomer with a particle size of 250 μm or smaller is selected. In other words, in Patent Document 1, possibly as a result of the polymerization method, PAS polymer with a particle size of 250 μm or greater is productized, and separated from PAS oligomer with a particle size of 250 μm or smaller.

In Patent Document 2, a method is proposed in which a phase separation agent is used to implement polymerization, so that PAS oligomer is removed from a slurry of granular PAS, PAS oligomer, organic polar solvent, water, and halogenated alkali metal salt. Specifically, an 80 mesh (175 μm) sieve is used to separate granular PAS, after which a glass filter of aperture 10 to 16 μm is used to separate the PAS oligomer. In this case, the PAS oligomer selected has a distribution ranging from a minimum particle size of from 10 to 16 μm to a maximum particle size of 175 μm.

In Patent Document 3, a manufacturing method for PAS resin is proposed wherein the PAS oligomer obtained using the method in Patent Document 2 is subjected to thermal oxidation in a gas oxidizing atmosphere at from 150 to 260° C., in order to reduce volatile substances.

However, these citations do not specifically disclose the problems occurring when recovering raw material fine PAS powder for use as product from separation liquid, or any problems with quality when compared to that of a regular product.

### CITATION LIST

### Patent Literature

Patent Document 1: Japanese Unexamined Patent Application Publication No. H05-93068

Patent Document 2: Japanese Unexamined Patent Application Publication No. 2007-002172

Patent Document 3: Japanese Unexamined Patent Application Publication No. 2007-016142

### SUMMARY OF INVENTION

### Technical Problem

The inventors of the present invention focused on the product rate of raw material fine PAS powder recovered as a solid via solid-liquid separation by filtration and the like of the separation liquid produced by the solid-liquid separation of the PAS-containing reaction solution, in order to meet the market demand for reduced costs and improved environmental impact.

The inventors of the present invention considered the main factors impeding the recovery of raw material fine PAS powder as product, when compared to productization granular PAS, to be (i) the high proportion of low polymer, which is easily degraded by heat, (ii) the microscopic particulate substance (hereinafter sometimes referred to as “fine powder”), and further, (iii) the fact that the heat treatment implemented with the objective of modification to reduce volatile substances and the like does not function as intended.

In other words, PAS polymeric substances are known to have different levels of thermal stability depending on its molecular weight; the lower the polymer, the stronger its tendency to be easily degraded by heat in comparison with substances with a high molecular weight, and the high number of low polymers included in raw material fine PAS powder is problematic.

Furthermore, the low polymer included in raw material fine PAS powder is partially formed from a fine powder comprising a microscopic particulate form substance, and is not easily removed by washing. Since it is a fine powder, it is difficult to be obtained sufficiently by washing, thus the organic amide solvent, byproduct alkali metal salts, and impurities (volatile substances and substances with high boiling point) are present between and within the fine powder particles. This is believed to have a significant impact on the quality of raw material fine PAS powder when it is productized.

The inventors of the present invention discovered that under these conditions, if conventional heat treatment is applied with the objective of modification of the wet cake-type raw material fine PAS powder after solid-liquid separation using filtration and the like of the separation liquid when productizing fine PAS powder, since the thermal history is not accurately adjusted, the surface of particles of raw material fine PAS powder is rendered as a structure that makes it difficult for volatilization of thermolysis products produced during low polymer thermolysis (for example, benzene compound containing sulfur, benzene compound containing halogen, halogenated compound containing nitrogen, organic compounds, substances with low boiling point containing sulfur, and the like) to take place in the form of gas generation from inside the fine powder to outside the fine powder. As a result, these thermolysis products are either absorbed into or between the fine powder, or are attached to it, and remain so.

If fine PAS powder in this state is productized, for example, the low polymer is subjected to thermolysis, and volatilizes as generated gas during the melt mold process, which may cause the formed surface to become wavy or wrinkled, causing problems with quality, and with the potential for safety and hygiene problems such as damage to the working environment.

The inventors of the present invention discovered that in productizing the fine PAS powder, even if the washing effect is not sufficiently expressed due to the substance being a fine powder, accurately adjusting the thermal history when implementing heat treatment and the like creates a fine powder structure in which it is easy for low polymers and impurities to be volatilized outside of the fine powder, allowing the formation of a fine PAS powder in which it is difficult for low polymers and impurities to remain within the fine powder. Additionally, they discovered that accurately adjusting the thermal history increases the fine PAS powder melt viscosity and weight average molecular weight, allowing it to be improved to the point where it is useful for practical purposes, meaning that raw material fine PAS powder that was formerly disposed of can be recovered as a product.

In this way, the inventors of the present invention pursued research into the product rate of small quantities of raw material fine PAS powder obtained from separation liquid that was conventionally disposed of in granular PAS manufacture, and by using a series of steps of pre-heat treatment and heat treatment, achieved a reduction in the generation of generated gas during the melt mold process, as well as improving the melt viscosity and weight average molecular weight of the thus obtained fine PAS powder (hereinafter sometimes referred to as “heat treated fine PAS powder”) to the extent that it can be put to practical use, and obtaining a high product rate thereof, thereby arriving at the present invention.

The present invention provides a heat treated fine PAS powder, obtained from the separation liquid produced by solid-liquid separation in a separation step during a manufacturing method for granular PAS that includes a polymerization step and the separation step, wherein the generated gas generated during the melt mold process is reduced, and furthermore the melt viscosity and weight average molecular weight are improved to the extent that the fine PAS powder can be put to practical use; and a manufacturing method for the heat treated fine PAS powder.

Furthermore, the present invention also provides a resin composition containing the productized heat treated fine PAS powder and granular PAS.

### Solution to Problem

According to the present invention, provided is a heat treated fine PAS powder, wherein
(i) the heat treated fine PAS powder is manufactured from a separation liquid produced when a granular PAS is manufactured via a manufacturing step, the manufacturing step including the following steps: a polymerization step, wherein at least one sulfur source selected from the group consisting of an alkali metal sulfide and an alkali metal hydrosulfide and a dihalo aromatic compound are subjected to a polymerization reaction in organic amide solvent, and a separation step, wherein a reaction solution containing produced granular PAS is separated into the granular PAS and the separation liquid through solid-liquid separation;
(ii) the heat treated fine PAS powder is obtained by subjecting the separation liquid to solid-liquid separation to obtain a raw material fine powder PAS, then subjecting the raw material fine powder PAS to pre-heat treatment and heat treatment;
(iii) the heat treated fine PAS powder has an average particle size of from 1 to 80 μm;
(iv) the heat treated fine PAS powder has a melt viscosity of 1 Pa·s or greater; and
(v) a generated gas amount of the heat treated fine PAS powder is 10 ppm or less.

Furthermore, according to the present invention, provided is a manufacturing method for manufacturing a heat treated fine PAS powder, the manufacturing method comprising the following steps:
(a) a polymerization step, wherein at least one sulfur source selected from the group consisting of an alkali metal sulfide and an alkali metal hydrosulfide and a dihalo aromatic compound are subjected to a polymerization reaction in organic amide solvent;
(b) a separation step, wherein a reaction solution containing produced granular PAS is separated into the granular PAS and a separation liquid through solid-liquid separation;
(c) a solid-liquid separation step, wherein the separation liquid is subjected to solid-liquid separation to obtain a raw material fine powder PAS;
(d) a pre-heat treatment step, wherein the raw material fine powder PAS is preheated at from 50 to 150° C. to obtain a pre-heat treated raw material fine powder PAS; and
(e) a heat treatment step, wherein the pre-heat treated raw material fine powder PAS is heat treated to obtain a heat treated fine powder PAS.

### Advantageous Effects of Invention

The heat treated fine PAS powder of the present invention has melt viscosity and weight average molecular weight that have been improved to the extent that the fine PAS powder can be put to practical use. The melt viscosity is from 50% to 150% of that of granular PAS melt viscosity of a regular product, and is typically a minimum of 1 Pa·s. Furthermore, the heat treated fine PAS powder of the present invention forms a reduced quantity of generated gas during the melt mold process, allowing improvements to the workplace environment during the forming step, and offers a good product rate, leading to the reuse of a product that has been conventionally disposed of

Furthermore, the manufacturing method for manufacturing the heat treated fine PAS powder of the present invention is a manufacturing method that manufactures heat treated fine PAS powder from separation liquid after solid-liquid separation, which was conventionally disposed of, and thereby reduces costs previously required for disposal, as well as reducing waste, and contributing to improvements in environmental impact.

The heat treated fine PAS powder of the present invention can be combined in a granular PAS compound as a component thereof without losing any of the attributes of the compound. As a result of this, it is possible to reduce the quantity of granular PAS used, and furthermore to contribute to reducing the manufacturing costs of PAS.

### Description of Embodiments

The heat treated fine PAS powder of the present invention is a heat treated fine PAS powder manufactured from the separation liquid, separated during the manufacture of granular PAS in a manufacturing method including a polymerization step and a separation step. Hereinafter, in I. and II. below, firstly, the manufacture of granular PAS is described.

I. Polymerization Reaction Components
1. Sulfur Source

At least one sulfur source selected from the group consisting of an alkali metal sulfide and an alkali metal hydrosulfide is used as the sulfur source. Examples of alkali metal sulfide include lithium sulfide, sodium sulfide, potassium sulfide, rubidium sulfide, cesium sulfide, and a mixture of two or more of these. Examples of alkali metal hydrosulfide include lithium hydrosulfide, sodium hydrosulfide, potassium hydrosulfide, rubidium hydrosulfide, cesium hydrosulfide, and a mixture of two or more of these.

The alkali metal sulfide may be in the form of anhydrate, hydrate or aqueous solution. Of these, from the perspective of the low cost of obtaining it for industrial purposes, sodium sulfide and lithium sulfide are preferred. It is preferable for the alkali metal sulfide to be an aqueous mixture such as a solution (in other words, a fluid mixture including water), from the point of view of ease of processing and measuring.

The alkali metal hydrosulfide may be in the form of anhydrate, hydrate, or aqueous solution. Of these, from the perspective of the low cost of obtaining it for industrial purposes, sodium hydrosulfide and lithium hydrosulfide are preferred. It is preferable for the alkali metal hydrosulfide to be an aqueous mixture such as a solution (in other words, a mixture including fluid water), from the point of view of ease of processing and measuring.

A small quantity of alkali metal hydrosulfide may be included within the alkali metal sulfide. In this case, the total mol amount of the alkali metal sulfide and alkali metal hydrosulfide is that of the sulfur source accompanying the polymerization reaction in the polymerization step after the dehydration step implemented where necessary, in other words the “charged sulfur source”.

A small quantity of alkali metal sulfide may be included within the alkali metal hydrosulfide. In this case, the total mol amount of the alkali metal hydrosulfide and alkali metal sulfide is the charged sulfur source. If the alkali metal sulfide and alkali metal hydrosulfide are mixed and used, then naturally, the mixture of the two will be the charged sulfur source.

If the sulfur source includes an alkali metal hydrosulfide, alkali metal hydroxide is used as well. Examples of alkali metal hydroxide include lithium hydroxide, sodium hydroxide, potassium hydroxide, rubidium hydroxide, cesium hydroxide, and a mixture of two or more of these. Of these, from the perspective of the low cost of obtaining it for industrial purposes, sodium hydroxide and lithium hydroxide are preferred. It is preferable for the alkali metal hydroxide to be used in an aqueous solution or an aqueous mixture.

In the PAS manufacturing method, the water content that should be removed by the dehydration step is hydrated water, an aqueous medium of an aqueous solution, water that is the byproduct of the reaction between an alkali metal hydrosulfide and an alkali metal hydroxide, and the like.

2. Dihalo Aromatic Compound

A dihalo aromatic compound (DHA) is a dihalogenated aromatic compound having two halogen atoms bonded directly to the aromatic ring. Halogen atoms include atoms of fluorine, chlorine, bromine, and iodine, and in the same dihalo aromatic compound the two halogen atoms may be the same, or different. These dihalo aromatic compounds may be used alone or in a combination of two or more types. Specific examples of dihalo aromatic compounds include o-dihalobenzene, m-dihalobenzene, p-dihalobenzene, dihalotoluene, dihalo naphthalene, methoxy-dihalobenzene, dihalobiphenyl, dihalobenzoic acid, dihalo diphenyl ether, dihalo diphenyl sulfone, dihalodiphenyl sulfoxide, dihalodiphenyl ketone. Of these, p-dihalobenzene, m-dihalobenzene or a mixture of these two is preferred, with p-dihalobenzene particularly preferred, and p-dichlorobenzene (pDCB) is particularly preferred.

3. Branching/Cross-Linking Agent

In order to introduce a branching or cross-linking structure to the formed PAS, it is possible to use in combination a polyhalo compound bonded with a minimum of 3 halogen atoms (this does not have to be an aromatic compound), a halogenated aromatic compound including active hydrogen, a halogenated aromatic nitro compound, or the like. Trihalobenzene is the preferred polyhalo compound for use as a branching/cross-linking agent. Furthermore, it is possible to use in combination a monohalo compound in order to form a tip of specific structure on the produced PAS resin, or to adjust the polymerization reaction or molecular weight. The monohalo compound may be, in addition to a monohalo aromatic compound, a monohalo aliphatic compound. The branching/cross-linking agent may be used in the range of 0.0001 to 0.01 mol per 1 mol charged sulfur source, preferably 0.0002 to 0.008 mol, and more preferably 0.0003 to 0.005 mol.

4. Organic Amide Solvent

An organic amide solvent that is an aprotic polar organic solvent is used as the dehydration reaction and polymerization reaction solvent. The organic amide solvent is preferably stable in regard to alkali at high temperatures. Specific examples of organic amide solvent include N,N-dimethyl formamide, N,N-dimethylacetoamide or other amide compounds; N-methyl-ε-caprolactam or other N-alkyl caprolactam compounds; N-methyl-2-pyrrolidone, N-cyclohexyl-2-pyrrolidone or other N-alkyl pyrrolidone compounds, or N-cycloalkyl pyrrolidone compounds; 1,3-dialkyl-2-imidazolidinone or other N,N-dialkyl imidazolidinone compounds; tetramethylurea or other tetraalkyl urea compounds; hexamethyl phosphate triamide or other hexaalkyl phosphate triamide compounds, and the like. These organic amide solvents may be used alone, or in a combination of two or more types.

Of these organic amide solvents, N-alkyl pyrrolidone compound, N-cycloalkyl pyrrolidone compound, N-alkyl caprolactam compound, and N,N-dialkyl imidazolidinone compound are preferred; in particular, N-methyl-2-pyrrolidone (NMP), N-methyl-ε-caprolactam, and 1,3-dialkyl-2-imidazolidinone are more preferred, and NMP is most preferred.

5. Polymerization Auxiliary Agent

Where required, to promote the polymerization reaction, various types of polymerization auxiliary agent may be used. Specific examples of polymerization auxiliary agents include well-known typical polymerization auxiliary agents for PAS including water, organic carboxylic acid metal salt, organic sulfonic acid metal salt, halogenated lithium or other alkali metal halides, alkaline earth metal halide, alkaline earth metal salt of aromatic carboxylic acid, phosphoric acid alkali metal salt, alcohol, paraffin hydrocarbon, or a mixture of two or more of these. An alkali metal carboxylate is preferred as the organic carboxylic acid metal salt. Examples of alkali metal carboxylate include lithium acetate, sodium acetate, potassium acetate, sodium propionate, lithium valerate, lithium benzoate, sodium benzoate, sodium phenyl acetate, potassium p-tolulate, or a mixture of two or more of these. Sodium acetate is particularly preferred as an alkali metal carboxylate due to the low cost of obtaining it. The quantity of polymerization auxiliary agent used depends on the compound, but is typically in the range of 0.01 to 10 mol, preferably 0.1 to 2 mol, more preferably 0.2 to 1.8 mol, and particularly preferably 0.3 to 1.7 mol per 1 mol of charged sulfur source.

If the polymerization auxiliary agent is an organic carboxylic metal salt, organic sulfonate, or alkali metal halide, the upper limit for use is preferably 1 mol or less, and more preferably 0.8 mol or less per 1 mol of charged sulfur source.

6. Phase Separation Agent

Various phase separation agents may be used in order to accelerate the polymerization reaction and achieve a high degree of polymerization in PAS in a short space of time, or to cause phase separation and obtain granular PAS. Phase separation agents are compounds that dissolve in organic amide solvent either on their own or in the presence of a small quantity of water, and reduce the solubility of PAS in organic amide solvent. The phase separation agent itself is a compound that is not a PAS solvent.

Any compound known to function as a phase separation agent in the general technical field of PAS may be used as the phase separation agent. Phase separation agents include the compounds used as the abovementioned polymerization auxiliary agent, but here, “phase separation agent” indicates a compound that can be used in the quantitative ratio that allows it to function as a phase separation agent in a step that implements a polymerization reaction in a phase-separated state, in other words a phase-separated polymerization step, or in the quantitative ratio sufficient to cause phase separation in the present of the phase separation agent after the completion of polymerization. Specific examples of phase separation agent include water, organic carboxylic acid metal salt, organic sulfonic acid metal salt, halogenated lithium or other alkali metal halides, alkaline earth metal halide, alkaline earth metal salt of an aromatic carboxylic acid, phosphoric acid alkali metal salt, alcohol, paraffin hydrocarbon, and the like. Preferred examples of organic carboxylic acid metal salt include lithium acetate, sodium acetate, potassium acetate, sodium propionate, lithium valerate, lithium benzoate, sodium benzoate, sodium phenyl acetate, potassium p-tolulate, and other alkali metal carboxylate. These phase separation agents may be used alone, or in a combination of two or more types. Of these phase separation agents, either water, which is cheap to obtain and easy to post-process, or a mixture of water with alkali metal carboxylate or other organic carboxylic acid metal salt are particularly preferred.

Even if water is used as the phase separation agent, it is possible to use in combination a phase separation agent other than water as a polymerization auxiliary agent, from the perspective of implementing phase-separated polymerization efficiently. If both water and a separate phase separation agent are used during the phase-separated polymerization step, the total quantity may be any quantity that allows phase separation to be implemented. At least part of the phase separation agent may be included from the time the polymerization reaction component is prepared, but it is preferable for a sufficient quantity of the phase separation agent to be added during the polymerization reaction, or after the polymerization reaction, in order for phase separation to occur.

II. Polymerization Step

The manufacture of PAS is implemented by the production of granular PAS through a polymerization reaction between at least one sulfur source selected from the group consisting of an alkali metal sulfide and an alkali metal hydrosulfide and a dihalo aromatic compound in organic amide solvent. In other words, a polymerization step wherein a polymerization reaction is caused between at least one sulfur source selected from the group consisting of an alkali metal sulfide and an alkali metal hydrosulfide and a dihalo aromatic compound in organic amide solvent is required in the present invention.

Any polymerization method may be used in the present invention, providing that it does not damage the present invention, and is a polymerization method resulting in the manufacture of granular PAS.

In general, polymerization methods to manufacture granular PAS can be broadly divided into (i) methods wherein the polymerization step includes a phase-separated polymerization step, and after phase-separated polymerization gradual cooling is implemented, (ii) methods wherein a phase separation agent is added after the polymerization reaction, and gradual cooling is implemented, (iii) methods using lithium chloride or other polymerization auxiliary agents, and (iv) methods wherein the reactor gas is cooled.

Of these, since when granular PAS is manufactured using a polymerization method including a polymerization reaction step implemented under phase-separated conditions, wherein polymerization conditions are controlled, and a concentrated polymer phase and a diluted polymer phase are present in the polymerization reaction system in the presence of a phase separation agent (hereinafter sometimes referred to as a “phase-separated polymerization step”), granular PAS with a high degree of polymerization can be obtained, it is possible to use a sieve screen with a small aperture size. This is an effective polymerization method in order to raise the recovery ratio of granular PAS product with a high level of polymerization.

In other words, this polymerization step, wherein granular PAS is produced by a polymerization reaction between at least one sulfur source selected from the group consisting of an alkali metal sulfide and an alkali metal hydrosulfide and a dihalo aromatic compound in organic amide solvent, is a polymerization step including a polymerization reaction in a phase-separated condition, wherein a concentrated polymer phase and a diluted polymer phase are present in combination.

This polymerization step is described in detail.

1. Preparation Step

The polymerization step including the manufacturing method wherein the heat treated fine PAS powder in the present invention is manufactured may be implemented after the preparation step described below.

The preparation step involves combining the mixture remaining within the system after the desired dehydration step with dihalo aromatic compound, adding alkali metal hydroxide and water as necessary, to prepare a charged mixture containing organic amide solvent, sulfur source (charged sulfur source), alkali metal hydroxide, water, and dihalo aromatic compound. If the distilled volume of organic amide solvent during the dehydration step is too high, organic amide solvent may be added during the preparation step. Furthermore, a sulfur source may also be added during the preparation step, in order to prepare the charged sulfur source. In general, since the quantity of each component in the dehydration step and the quantitative ratio changes, adjustment of the quantity of each component in the preparation step needs to be done in consideration of the quantity of each component in the mixture obtained in the dehydration step.

The quantity of dihalo aromatic compound used is typically from 0.90 to 1.50 mol, preferably from 0.92 to 1.10 mol, and more preferably from 0.95 to 1.05 mol per 1 mol charged sulfur source. If the preparation mol ratio of dihalo aromatic compound to sulfur source is too large, it becomes difficult to produce a high molecular weight polymer. On the other hand, if the preparation mol ratio of dihalo aromatic compound to sulfur source is too small, it becomes easier for a degradation reaction to occur, and difficult to implement a stable polymerization reaction.

In particular, if alkali metal hydrosulfide is used as the sulfur source, and hydrogen sulfide volatilizes during the dehydration step, a balanced reaction causes the production of alkali metal hydroxide, which remains within the system. Accordingly, it is necessary to accurately ascertain the quantity that will volatilize, and determine the mol ratio of alkali metal hydroxide to sulfur source in the preparation step. The total mol value of the mol value of alkali metal hydroxide produced during dehydration, the mol value of the alkali metal hydroxide added prior to dehydration, and the mol value of alkali metal hydroxide added subsequent to dehydration is preferably within the range of 1.005 to 1.09 mol, more preferably 1.01 to 1.08 mol, and particularly preferably 1.015 to 1.075 mol per 1 mol charged sulfur source, in other words the sulfur source remaining in the system after the dehydration step; furthermore, the water mol value is adjusted to from 0.01 to 2.0 mol, preferably from 0.05 to 1.8 mol, more preferably from 0.5 to 1.6 mol per 1 mol of charged sulfur source.

In the present invention the sulfur source used in the preparation step is referred to as the “charged sulfur source”, in order to distinguish it from the sulfur source used in the dehydration step. The reason for this is that prior to the dehydration step, the quantity of sulfur source added to the reaction chamber varies according to the dehydration step. The charged sulfur source is consumed during the polymerization step by reaction with the dihalo aromatic compound, and the charged sulfur source mol amount is based on the mol amount in the preparation step. The volume of charged sulfur source is calculated using the formula [charged sulfur source]=[total prepared sulfur mol]−[volatized sulfur after dehydration mol].

If the alkali metal hydroxide mol ratio per 1 mol of charged sulfur source is too high, the organic amide solvent degradation will increase, causing an irregular reaction or a degradation reaction during polymerization. Furthermore, in many cases, the collection rate and quality of produced PAS will be reduced. Implementing the polymerization reaction in a state where there is a slight excess of alkali metal hydroxide allows the polymerization reaction to be stably implemented, and is preferable in order to obtain high quality PAS.

In the preparation step, the quantity of organic amide solvent is typically from 0.1 to 10 kg, preferably from 0.13 to 5 kg, and more preferably from 0.15 to 2 kg per 1 mol of charged sulfur source.

2. Polymerization Step

In the polymerization step, the charged mixture prepared in the aforementioned preparation step is heated typically to from 170 to 290° C., preferably from 180 to 280° C., and more preferably from 190 to 275° C. before the polymerization reaction is started, in order to progress the polymerization. Heating methods include a method wherein a fixed temperature is maintained, a method of heating in stages or continually, or a combination of both methods. The time required for the polymerization reaction is in general from 10 minutes to 72 hours, and preferably from 30 minutes to 48 hours. The polymerization reaction is preferably implemented in two stages, in the form of a first polymerization step and a second polymerization step, in which case the time taken for polymerization will be the total time taken in the first polymerization step and the second polymerization step.

In this polymerization step, a polymerization reaction is caused between at least one sulfur source selected from the group consisting of an alkali metal sulfide and an alkali metal hydrosulfide and a dihalo aromatic compound in organic amide solvent, wherein the polymerization reaction occurs in a phase-separated state with a concentrated polymer phase and a diluted polymer phase being present in the polymerization reaction system in the presence of a phase separation agent. The polymerization reaction is caused at a temperature of from 170 to 290° C. The phase separation agent is preferably water, as described above, or any compound known to function as a phase separation agent.

Furthermore, in the polymerization step, it is preferable for a polymerization reaction to be caused between at least one sulfur source selected from the group consisting of an alkali metal sulfide and an alkali metal hydrosulfide and a dihalo aromatic compound in organic amide solvent at a temperature of from 170 to 270° C., and at the point at which the conversion ratio of the dihalo aromatic compound reaches a minimum of 30%, for a phase separation agent to be added to the polymerization reaction mixture to cause the phase separation agent to be present within the polymerization reaction system, after which the temperature of the polymerization reaction mixture is raised to a temperature from 245 to 290° C., and the polymerization reaction is continued in a phase-separated state with a concentrated polymer phase and a diluted polymer phase present in the polymerization reaction system in the presence of a phase separation agent.

Furthermore, in the polymerization step, it is preferable for the polymerization reaction to be carried out in a two-stage polymerization step: a first stage polymerization step including a polymerization reaction caused between at least one sulfur source selected from the group consisting of an alkali metal sulfide and an alkali metal hydrosulfide and a dihalo aromatic compound in organic amide solvent, wherein the produced polymer has a conversion ratio of the dihalo aromatic compound of a minimum of 30% and preferably from 80 to 99%, and a second polymerization step including the polymerization reaction continued in a phase-separated state with a concentrated polymer phase and a diluted polymer phase present in the polymerization reaction system in the presence of a phase separation agent.

Specifically, in the polymerization step, it is preferable for the polymerization reaction to be carried out in an at least two-stage polymerization step: a first polymerization step including a polymerization reaction caused between at least one sulfur source selected from the group consisting of an alkali metal sulfide and an alkali metal hydrosulfide and a dihalo aromatic compound in organic amide solvent, with from 0.01 to 2.0 mol water being present per 1 mol of charged sulfur source, and the temperature being from 170 to 270° C., wherein the produced polymer has a conversion ratio of the dihalo aromatic compound of from 80 to 99%; and a second polymerization step, including the polymerization reaction continued in a phase-separated state, with a concentrated polymer phase and a diluted polymer phase present in the polymerization reaction system, by not only adjusting the water content of the polymerization reaction system so that greater than 2.0 mol but 10 mol or less of water per 1 mol charged sulfur source is present, but also heating to from 245 to 290° C.

The first polymerization step, as described above, takes place after the start of the polymerization reaction, when the dihalo aromatic compound conversion ratio reaches from 80 to 99%, preferably from 85 to 98%, and more preferably from 90 to 97%. If the polymerization temperature is too high during the first polymerization step, side reactions and degradation reactions may occur.

The dihalo aromatic compound conversion ratio is the value calculated by the following formula. The conversion ratio of dihalo aromatic compound (hereinafter sometimes referred to as “DHA”) is calculated using the following formula when added at a mol ratio in excess of the sulfur source.

Conversion ratio=[[DHA preparation amount (mol)−DHA residual amount (mol)]/[DHA preparation amount (mol)−DHA excess amount (mol)]]×100

In all other cases, the conversion ratio is calculated using the following formula.

Conversion ratio=[[DHA preparation amount (mol)−DHA residual amount (mol)]/[DHA preparation amount (mol)]]×100

The coexisting water amount in the first polymerization step reaction system is typically within the range of 0.01 to 2.0 mol, preferably 0.05 to 1.8 mol, more preferably 0.5 to 1.6 mol, and particularly preferably 0.8 to 1.5 mol per 1 mol charged sulfur source. The coexisting water amount in the first polymerization step may be small, but if it is too small it becomes easier for degradation of the produced PAS or other undesirable reaction to occur. If the coexisting water amount exceeds 2.0 mol, the polymerization speed falls dramatically, and it becomes easy for the organic amide solvent and produced PAS to degrade, neither of which is desirable. The polymerization is carried out in the range of 170 to 270° C., and preferably 180 to 265° C. If the polymerization temperature is too low, the polymerization speed becomes too slow; alternatively, if it exceeds 270° C., the produced PAS and organic amide solvent tend to degrade, which will significantly reduce the level of polymerization of produced PAS.

In the first polymerization step, it is typically preferable for a melt viscosity measured at a temperature of 310° C., and a shear speed of 1,216 sec⁻¹ to produce a polymer (sometimes referred to as a pre-polymer) with from 0.5 to 30 Pa·s.

The second polymerization step is not simply a separating/granulating step for the polymer (pre-polymer) produced during the first polymerization step, but is also intended to increase the level of polymerization of the aforementioned polymer.

During the second polymerization step, it is preferable to include a phase separation agent (polymerization auxiliary agent) in the polymerization reaction system, and to continue the polymerization reaction in a phase-separated state, with a concentrated polymer phase and a diluted polymer phase present together.

In the second polymerization step, it is particularly preferable to use water as the phase separation agent, and preferable to adjust the quantity of water so that there is from greater than 2.0 mol to 10 mol or less, preferably from greater than 2.0 mol to 9 mol or less, more preferably from 2.1 to 8 mol, and particularly preferably from 2.2 to 7 mol of water in the polymerization reaction system per 1 mol of charged sulfur source. In the second polymerization step, if the coexisting water quantity in the polymerization reaction system is 2.0 mol or less or greater than 10 mol, per 1 mol of charged sulfur source, the level of polymerization of the produced PAS may fall. In particular, it is preferable if the second polymerization is implemented with coexisting water quantity in the range of 2.2 to 7 mol, as PAS with a high degree of polymerization will be obtained.

An even more preferred manufacturing method is to use a small quantity of phase separation agent in polymerization, which can be achieved by using in combination water and a phase separation agent other than water as the phase separation agent. In this configuration, it is preferable for the amount of water in the polymerization reaction system to be in the range of 0.1 to 10 mol, preferably 0.3 to 10 mol, more preferably 0.4 to 9 mol, and particularly preferably 0.5 to 8 mol per 1 mol charged sulfur source, and for the amount of the separation agent other than water to be in the range of 0.01 to 3 mol per 1 mol charged sulfur source. Other phase separation agents preferred for using in combination with water include organic carboxylic acid metal salts, particularly alkali metal carboxylates, in which case the amount of water per 1 mol charged sulfur source is in the range of 0.5 to 10 mol, preferably 0.6 to 7 mol, and particularly preferably 0.8 to 5 mol, while the amount of alkali metal carboxylate is in the range of 0.001 to 0.7 mol, preferably 0.02 to 0.6 mol, and particularly preferably 0.05 to 0.5 mol.

The polymerization temperature in the second polymerization step is in the range of 245 to 290° C.; if the polymerization temperature is below 245° C. it is difficult to obtain granular PAS with a high degree of polymerization, while if it exceeds 290° C., the granular PAS and organic amide solvent may be degraded. In particular, a temperature range of 250 to 270° C. is preferred because it yields granular PAS with a high degree of polymerization.

With the objectives of reducing the quantity of byproduct alkali metal salt (for example, NaCl) and impurities contained in the produced PAS and recovering PAS in particle form, water may be added at the end or after the completion of the polymerization reaction, thereby increasing the amount of water. The polymerization reaction may be by batch, continuous or a combination of both methods. If using batch polymerization, then it is possible to use a method with two or more reaction chambers, as desired, with the objective of shortening the polymerization cycle time.

3. The dehydration step, if desired

In manufacturing the heat treated fine PAS powder of the present invention, a dehydration step may be implemented prior to the preparation step for the polymerization step if desired.

It is preferable to implement a dehydration step prior to the polymerization step in order to adjust the volume of water in the reaction system. The dehydration step is preferably carried out in an inert gas environment, by heating a mixture containing organic amide solvent and alkali metal sulfide and causing a reaction, and releasing water from the system by distillation. If alkali metal hydrosulfide is used as the sulfur source, the mixture containing alkali metal hydrosulfide and alkali metal hydroxide is heated to cause a reaction, and water is released from the system by distillation.

In the dehydration step, water containing hydrated water (crystal water), aqueous medium, byproduct water, and the like are dehydrated to within the required range. Furthermore, in the dehydration step, water and organic amide solvent are heated and distilled out by being turned into steam. Accordingly, the distillate will contain water and organic amide solvent. Part of the distillate may be circulated within the system in order to control the release of organic amide solvent outside the system, but in order to adjust the water content, at least part of the distillate containing water must be released outside the system. When releasing the distillate outside of the system, a minute quantity of organic amide solvent will be released outside of the system alongside the water.

Furthermore, in the dehydration step, hydrogen sulfide is volatilized, due to the sulfur source. Alongside the release of at least part of the distillate containing water outside of the system, the volatilized hydrogen sulfide is also released outside the system.

During the dehydration step, the coexisting water quantity in the polymerization reaction system is dehydrated so that it is within the range typically of 0.01 to 2.0 mol, preferably 0.05 to 1.8 mol, and more preferably 0.5 to 1.6 mol per 1 mol of charged sulfur source. As described above, the sulfur source after the dehydration step and before the start of the polymerization step is referred to as the “charged sulfur source”. If the amount of water is reduced too far by the dehydration step, water may be added prior to the polymerization step in order to achieve the desired water content.

If alkali metal hydrosulfide is used as the sulfur source, then it is preferable if in the dehydration step a mixture containing from 0.9 to 1.1 mol, preferably from 0.91 to 1.08 mol, more preferably from 0.92 to 1.07 mol, and particularly preferably from 0.93 to 1.06 mol of alkali metal hydroxide per 1 mol of organic amide solvent, alkali metal hydrosulfide, and the aforementioned alkali metal hydrosulfide is heated and a reaction caused, and at least part of the distillate including water from the system containing the mixture is released outside of the system. In many cases, alkali metal hydrosulfide contains small amounts of alkali metal sulfide, and the amount of sulfur source is the total quantity of alkali metal hydrosulfide and alkali metal sulfide. Furthermore, even if a small quantity of alkali metal sulfide is mixed in, in the present invention the mol ratio in regard to alkali metal hydroxide can be calculated based on the quantity of alkali metal hydrosulfide included (analysis value), and the mol ratio adjusted.

If the mol ratio of alkali metal hydroxide per 1 mol of alkali metal hydrosulfide in the dehydration step is too small, the amount of sulfur component that volatilizes in the dehydration step (hydrogen sulfide) will be too large, resulting in a reduction in productivity due to a decreased sulfur source amount. After dehydration, the remaining charged sulfide source will have increased polysulfide content, causing irregular reactions, and tending to reduce the quality of produced PAS. If the mol ratio of alkali metal hydroxide per 1 mol of alkali metal hydrosulfide is too great, the organic amide solvent will degrade significantly, making it difficult to implement a stable polymerization reaction, and reducing both the recovery ratio and the quality of the produced PAS.

In the dehydration step, the addition of each raw material to the reaction chamber is typically done in the temperature range of ambient temperature (from 5 to 35° C.) to 300° C., and preferably ambient temperature to 200° C. The order in which raw materials are added may be discretionarily defined, and furthermore, additional amounts of each raw material may be added during the dehydration process. The solvent used in the dehydration step may be an organic amide solvent. It is preferable for this solvent to be the same as the organic amide solvent used in the polymerization step, and NMP is particularly preferred. The quantity of organic amide solvent used is typically approximately from 0.1 to 10 kg per 1 mol of sulfur source added to the reaction chamber.

The dehydration operation is implemented by heating the mixture obtained after adding the raw materials to the reaction chamber to a temperature typically of 300° C. or below, and preferably within the range of 100 to 250° C., and typically for from 15 minutes to 24 hours, and preferably from 30 minutes to 10 hours. Heating methods include a method wherein a fixed temperature is maintained, a method of heating in stages or continually, or a combination of both methods. The dehydration step may be by batch, continuous or a combination of both.

The device used for the dehydration step may be the same reaction chamber (reaction vessel) as that used in the subsequent polymerization step, or a different one. The device is preferably made of a corrosion-resistant material such as titanium.

Another preferred configuration for obtaining granular PAS is the method wherein after polymerization has been completed, sufficient adjustment is made to volume to allow the formation of separate phases, and cooling is implemented gradually.

III. Separation Step

The heat treated fine PAS powder of the present invention is manufactured using a manufacturing method for manufacturing heat treated fine PAS powder, the manufacturing method including the following steps:

(a) a polymerization step, wherein at least one sulfur source selected from the group consisting of an alkali metal sulfide and an alkali metal hydrosulfide and a dihalo aromatic compound are subjected to a polymerization reaction in organic amide solvent, and

(b) a separation step, wherein the reaction solution containing produced granular PAS is separated into granular PAS and separation liquid through solid-liquid separation, and

(c) a solid-liquid separation step, wherein the separation liquid is subjected to solid-liquid separation to obtain raw material fine PAS powder, and

(d) a pre-heat treatment step, wherein the raw material fine PAS powder is preheated at from 50 to 150° C. to obtain pre-heat treated raw material fine PAS powder, and

(e) a heat treatment step, wherein the pre-heat treated raw material fine PAS powder is heat treated to obtain heat treated fine PAS powder.

The manufacturing method for manufacturing the heat treated fine PAS powder of the present invention is a manufacturing method is only required to include the (a) polymerization step, (b) separation step, (c) solid-liquid separation step, (d) pre-heat treatment step and (e) heat treatment step detailed above; other steps, for example, where necessary, a step to concentrate or dilute the reaction solution and separation liquid, a washing step, or a drying step, and the like may be added, or one or multiple of the steps in (a) to (e), and particularly the steps in (c) to (e) may be additionally performed.

The heat treated fine PAS powder of the present invention is obtained from the separation liquid obtained by solid-liquid separation as part of the manufacturing method described above to manufacture heat treated fine PAS powder, while at the same time, granular PAS is manufactured and recovered from the solids obtained after solid-liquid separation. Below is an example of the properties of a preferred granular PAS recovered as a product.

In the granular PAS manufacturing method, the separation recovery process for granular PAS, which occurs after the polymerization step, may be implemented, for example, by a separation step in which a sieve is used. Once the polymerization reaction has been completed, the separation step may be implemented using a sieve to separate and recover granular PAS from a product slurry, which is the reaction solution containing produced granular PAS, after the product slurry is cooled and diluted with water as necessary.

As previously noted, according to this manufacturing method for granular PAS, granular PAS can be produced. As a result, separation via a sieve with a screen can be implemented. Furthermore, the product slurry can be sieved to separate granular PAS at high temperatures, without the need to cool it to room temperature.

The aperture size of the screen used for separation in the separation step by sieving is typically from 75 μm (200 mesh) to 180 μm (80 mesh), and preferably from 90 μm (170 mesh) to 150 μm (100 mesh). At least one screen within this range may be used, or multiple levels may also be used. Typically a screen with aperture size of 150 μm (100 mesh) is used.

The recovery ratio of granular PAS recovered as product is calculated as the entire amount of PAS obtained, based on the mass (theoretical amount) of PAS when it is assumed that all the effective sulfur component within the charged sulfur source present in the reaction vessel after the dehydration step has been converted into PAS.

This recovery ratio also depends on the screen aperture size of the sieve, but if at least one screen with an aperture size of from 75 μm (200 mesh) to 180 μm (80 mesh) is used, the ratio will typically be a minimum of 80 mass %, in some cases a minimum of 83 mass %, and in some cases a minimum of 85 mass %. The maximum recovery ratio is around 99.5 mass %.

Furthermore, the average particle size of the obtained granular PAS depends on the sieve screen aperture size, but when using at least one screen in the range of 75 μm (200 mesh) to 180 μm (80 mesh), it will typically be from 130 to 1,500 μm, preferably, from 150 to 1,500 μm, and more preferably, from 180 to 1,500 μm.

The weight average molecular weight of the obtained granular PAS depends on the sieve screen aperture size, but when using at least one screen in the range of 75 μm (200 mesh) to 180 μm (80 mesh), the granular PAS weight average molecular weight will typically be a minimum of 30,000, preferably a minimum of 33,000, and more preferably, a minimum of 35,000. The upper limit of the weight average molecular weight is approximately 90,000.

Furthermore, the peak top molecular weight of the granular PAS depends on the sieve screen aperture size, but when using at least one screen in the range of 75 μm (200 mesh) to 180 μm (80 mesh), it will typically be a minimum of 35,000, preferably a minimum of 38,000, and more preferably a minimum of 40,000. The maximum peak top molecular weight is approximately 100,000.

The melt viscosity of the obtained granular PAS depends on the sieve screen aperture size, but when using at least one screen in the range of 75 μm (200 mesh) to 180 μm (80 mesh), the granular PAS melt viscosity will typically be a minimum of 5 Pa·s, preferably a minimum of 10 Pa·s, and more preferably a minimum of 15 Pa·s. The maximum melt viscosity is around 500 Pa·s. Melt viscosity is measured using a flat die having a diameter of 1 mm and length of 10 mm as a capillary, at a temperature of 310° C. A polymer sample is inserted in the device, and after the sample is retained there for 5 minutes, melt viscosity is measured at shear speed 1,216 sec⁻¹.

IV. Manufacture (Recovery) of Heat Treated Fine PAS Powder from Separation Liquid

(IV-1) In manufacturing granular PAS, the separation liquid that is produced when granular PAS is separated in the separation step often contains, for example, raw material fine PAS powder, byproduct alkali metal salt (NaCl and the like), oligomers, impurities including volatile substances and substances with high boiling point, organic amide solvent, and phase separation agent (water and the like).

In other words, the heat treated fine PAS powder of the present invention is the heat treated fine PAS powder manufactured from the separation liquid, which is produced when granular PAS is manufactured in a manufacturing step including a polymerization step, wherein at least one sulfur source selected from the group consisting of an alkali metal sulfide and an alkali metal hydrosulfide and a dihalo aromatic compound are subjected to a polymerization reaction in organic amide solvent, and a separation step, wherein the reaction solution containing produced granular PAS is separated into granular PAS and separation liquid through solid-liquid separation.

The heat treated fine PAS powder of the present invention is heat treated fine PAS powder that can be productized, being a heat treated fine PAS powder obtained by obtaining raw material fine PAS powder by solid-liquid separation of the separation liquid, and subjecting the raw material fine PAS powder to pre-heat treatment and heat treatment.

Here, “obtaining raw material fine PAS powder by solid-liquid separation of the separation liquid” includes cases wherein the solid-liquid separation step is implemented directly on the separation liquid, as well as cases wherein the separation liquid is subjected to the pre-solid-liquid separation step described below, after which it is subjected to the solid-liquid separation step. The solid-liquid separation step, pre-heat treatment step and heat treatment step are implemented in the following manner.

(i) Solid-Liquid Separation Step

The solid-liquid separation step is the step wherein solid-liquid separation is implemented on the separation liquid to obtain raw material fine PAS powder. In the solid-liquid separation step, solid-liquid separation may be implemented by filtration, centrifugal separation, sieving, or precipitation. For example, filtration is often implemented, using a filtration device with a typical filter cloth for fine powder. Suction filtration devices are effective from the perspective of processing time. The solid-liquid separation step method may be continuous or batch. An example of a continuous method is that using a horizontal belt filtration device. An example of a batch filtration device is a filter press, which is preferable for use in cases where raw material fine PAS powder concentration is low from the perspective of processing amount.

The weight average molecular weight of the obtained raw material fine PAS powder depends on the sieve screen aperture size, but when using at least one screen in the range of 75 μm (200 mesh) to 180 μm (80 mesh), it will typically be a minimum of 15,000, preferably a minimum of 18,000, and more preferably a minimum of 20,000. The upper limit of the weight average molecular weight is approximately 75,000.

Furthermore, peak top molecular weight of the obtained raw material fine PAS powder depends on the sieve screen aperture size, but when using at least one screen in the range of 75 μm (200 mesh) to 180 μm (80 mesh), it will typically be a minimum of 30,000, preferably a minimum of 33,000, and more preferably a minimum of 35,000. The maximum peak top molecular weight is approximately 85,000.

The average particle size of the obtained raw material fine PAS powder is the value measured using a laser diffraction particle size distribution measuring device, and is typically from 1 to 80 μm, preferably from 2 to 80 μm, and more preferably from 3 to 80 μm.

The melt viscosity of the obtained raw material fine PAS powder is typically a minimum of 0.2 Pa·s, preferably a minimum of 0.6 Pa·s, and more preferably a minimum of 1.0 Pa·s. The maximum melt viscosity is approximately 50 Pa·s. The method of measuring melt viscosity is as described above.

(ii) Pre-Heat Treatment Step

In the pre-heat treatment step, the raw material fine PAS powder is subjected to pre-heat treatment. In other words, pre-heat treatment is implemented as the first stage of the heat treatment step described below. The solid raw material fine PAS powder that has been subjected to pre-heat treatment is referred to as “pre-heat treated raw material fine PAS powder”.

Pre-heat treatment may be implemented using batch or continuous methods. Pre-heat treatment may be implemented using a typical tank-shaped dryer, a rotating tank dryer, an air flow dryer, a fluid bed dryer or other dryers. The raw material fine PAS powder may be treated whilst static, but if there is a large quantity of raw material fine PAS powder to be pre-heat treated evenly, it is preferable to make the raw material fine PAS powder flow in some way. Methods of implementing pre-heat treatment while making the raw material fine PAS powder flow include dryers fitted with a fluidized bed, stirrers, paddles or stirring screws.

The pre-heat treatment may be implemented in an atmosphere of air or low oxygen concentration, or under nitrogen gas, carbon dioxide, steam or other inert gas. Furthermore, typically, it can be implemented under either reduced or increased pressure.

As described above, if the thermal history is not accurately adjusted, it becomes difficult for the generated gas to become volatilized. The implementation of this pre-heat treatment step in combination with the heat treatment step described below facilitates an accurate adjustment of thermal history, an increase in temperature of the fine powder, and the volatilization of the generated gas outside the fine powder, as well as improving melt viscosity and weight average molecular weight to the extent that they can stand up to practical use, and is therefore beneficial.

The temperature used in the pre-heat treatment step is typically in the range of 50 to 150° C., preferably 53 to 145° C., and more preferably, 55 to 140° C. Although it depends on pre-heat treatment time, if the temperature exceeds 150° C. the raw material fine PAS powder may experience an increase in viscosity due substantially to air oxidation.

The time required for pre-heat treatment step is typically from 0.3 to 10 hours, preferably from 0.5 to 6 hours, and more preferably from 1.0 to 4 hours.

From the perspective of thermal efficiency, pre-heat treatment preferably implemented in a dry atmosphere at 100° C. or above, but under reduced pressure it can be implemented at 100° C. or below, and is possible at 90° C. or below.

The level of pressure reduction is sufficient if in the range of 70 to 101 KPa.

(iii) Heat Treatment Step

The heat treatment of pre-heat treated raw material fine PAS powder may use continuous or batch methods. Heat treatment may be implemented using a typical hot air heat treatment device, a stirred heating device with blades, a fluidized bed heat treatment device, a rotating tank heat treatment device or other heat treatment device. The drying device in the pre-heat treatment step and the heat treatment device in the heat treatment step may be the same device.

The pre-heat treated raw material fine PAS powder may be heat treated whilst static, but if there is a large quantity of pre-heat treated raw material fine PAS powder to be heat treated evenly, it is preferable to make the pre-heat treated raw material fine PAS powder flow in some way. Methods of implementing heat treatment while making the pre-heat treated raw material fine PAS powder flow include using heat treatment devices fitted with a fluidized bed, stirrers, paddles, or stirring screws.

The pre-heat treatment may be implemented in an atmosphere of air or low oxygen concentration, or under nitrogen gas, carbon dioxide, steam, or other inert gas. Furthermore, it can be implemented under either regular pressure, reduced pressure, or increased pressure. The level of pressure reduction is sufficient if in the range of 70 to 101 KPa.

It is beneficial to implement heat treatment under inert gas atmospheric conditions where oxygen is not present, since this results in minimal coloration.

Heat treatment may be implemented up to below the melting point of the pre-heat treated raw material fine PAS powder, but typically it is implemented in the range of 160 to 260° C., more preferably 180 to 250° C., and even more preferably 200 to 240° C. Heat treatment time is typically from 0.5 to 6 hours, preferably from 1 to 5 hours and more preferably from 2 to 4. 5 hours. Heat treatment may be implemented under reduced pressure conditions. This heat treatment causes low polymers and impurities to be volatilized as generated gas. Since thermal history has been accurately adjusted, this pre-heat treatment step facilitates generated gas being volatilized. At the same time, removing low molecular weight substances results in the weight average molecular weight and melt viscosity of the heat treated fine PAS powder increasing. In order to volatilize low polymers, heat treatment at a minimum of 160° C. is required.

(IV-2) The Following Washing Step may also be Implemented Prior to the Pre-Heat Treatment Step.

[Washing Step]

The objective of this washing step is to reduce the concentration of the alkali metals (for example, the Na concentration) caused by byproduct alkali metal salts in the raw material fine PAS powder.

The washing liquid for use with raw material fine PAS powder is preferably a polymerization solvent, alcohol, acetone or other organic compound, water, acetic acid, acetic acid salt, hydrochloric acid, or a mixture of any of these. Preferably, water, acetic acid or other acid aqueous solution should be used.

In the present invention, water, alcohol, acetone, acetic acid, acetic acid salt, hydrochloric acid, or a mixture of these is used. After washing, filtration may be implemented. Filtration may be implemented the same number of times as washing.

(IV-3) Furthermore, prior to the solid-liquid separation step, a pre-solid-liquid separation step and byproduct alkali metal salt removal step may be implemented.

[Pre-Solid-Liquid Separation Step]

The pre-solid-liquid separation step is a solid-liquid separation step that involves using a method of separating the separation liquid into raw material fine PAS powder and filtration liquid, using filtration or another pre-solid-liquid separation method. When this is implemented, furthermore, acetone, and the like may be added to the raw material fine PAS powder to wash away the organic amide solvent included in the raw material fine PAS powder, after which filtration or other separate means may be implemented once again in order to obtain a washed raw material fine PAS powder.

[Byproduct Alkali Metal Salt Removal Step]

The byproduct alkali metal salt removal step is a step implemented after the pre-solid-liquid separation step in order to dissolve and remove byproduct alkali metal salt from the raw material fine PAS powder by washing with water.

The liquid included in the raw material fine PAS powder after it has been subjected to the pre-solid-liquid separation step and the byproduct alkali metal salt removal step is typically in the range of 0.1 to 15 mass % of the raw material fine PAS powder, preferably 0.15 to 10 mass %, and more preferably 0.2 to 5 mass %.

In this case, the preferred filtration separation in the solid-liquid separation step involves filtration using centrifugal filtration and a filter press, in order to obtain raw material fine PAS powder. In this case, the solid substance is recovered in the form of a wet cake.

(IV-4) The heat treated fine PAS powder after the heat treatment step is used as a product. Typically, the entire quantity is recovered, but separation may be performed with a sieve, allowing heat treated fine PPS powder of a specific particle size or greater to be used. For example, if granular PAS is sieved using an aperture size 150 μm (100 mesh) screen, the heat treated fine PAS powder obtained from the separation liquid can be separated by sieving with an aperture size 75 μm (200 mesh) screen. However, when heat treated fine PAS powder is separated using a sieve, the product rate falls.

V. Heat Treated Fine PAS Powder

The heat treated fine PAS powder of the present invention is:

(i) the heat treated fine PAS powder manufactured from the separation liquid produced during the manufacture of granular PAS in a manufacturing step, the manufacturing step including the following steps: a polymerization step, wherein at least one sulfur source selected from the group consisting of an alkali metal sulfide and an alkali metal hydrosulfide and a dihalo aromatic compound are subjected to a polymerization reaction in organic amide solvent, and a separation step, wherein the reaction solution containing produced granular PAS is separated into granular PAS and separation liquid through solid-liquid separation;

(ii) the heat treated fine PAS powder obtained when the separation liquid is subjected to solid-liquid separation to obtain raw material fine PAS powder, after which the raw material fine PAS powder is subjected to pre-heat treatment and heat treatment;

(iii) the heat treated fine PAS powder with an average particle size from 1 to 80 μm;

(iv) the heat treated fine PAS powder with a melt viscosity of 1 Pas or greater; and

(v) the heat treated fine PAS powder with a generated gas amount of 10 ppm or lower.

The heat treated fine PAS powder that is subjected to the heat treatment step of the present invention may be combined to make a product with the conventional productized granular PAS obtained from the surface of the sieve after sieving in the separation step described above, to form a resin composition (compound).

The weight average molecular weight of the obtained heat treated fine PAS powder depends on the screen aperture size of the sieve, but if at least one screen with aperture size of from 75 μm (200 mesh) to 180 μm (80 mesh) is used in recovery, it will typically be a minimum of 30,000, preferably a minimum of 33,000, and more preferably a minimum of 35,000. The upper limit of the weight average molecular weight is approximately 90,000.

Furthermore, the obtained heat treated fine PAS powder peak top molecular weight depends on the screen aperture size of the sieve, but if at least one screen with aperture size of from 75 μm (200 mesh) to 180 μm (80 mesh) is used in recovery, it will typically be a minimum of 32,000, preferably a minimum of 34,000, and more preferably a minimum of 36,000. The maximum peak top molecular weight is approximately 100,000.

Furthermore, the obtained heat treated fine PAS powder melt viscosity depends on the screen aperture size of the sieve, but if at least one screen with aperture size of from 75 μm (200 mesh) to 180 μm (80 mesh) is used in recovery, then in ratio to the melt viscosity of granular PAS obtained in the separation step, it will be from 50% to 150% of granular PAS melt viscosity, preferably 55% to 130%, more preferably 58% to 120%, and particularly preferably 65% to 110%. Measurement of melt viscosity is performed as described above.

Furthermore, the melt viscosity is typically a minimum of 1 Pa·s, preferably a minimum of 3 Pa·s, more preferably a minimum of 5 Pa·s, and particularly preferably a minimum of 10 Pa·s. The maximum melt viscosity is approximately 500 Pa·s. The melt viscosity of heat treated fine PAS powder is typically from 2 to 30 times, preferably from 5 to 30 times, and more preferably from 8 to 30 times that of raw material fine PAS powder.

The obtained heat treated fine PAS powder is believed to have a higher weight average molecular weight than the raw material fine PAS powder present in the separation liquid because of the removal of low molecular weight substances during the heat treatment step.

The average particle size of the obtained heat treated fine PAS powder depends on the screen aperture size of the sieve, but if at least one screen with aperture size of from 75 μm (200 mesh) to 180 μm (80 mesh) is used in recovery, it will typically be from 1 to 80 μm, preferably from 2 to 80 μm, and more preferably from 3 to 80 μm based on the value measured using a laser diffraction particle size distribution device.

The product rate of the obtained heat treated fine PAS powder passing through each of the steps of the present invention depends on the screen aperture size of the sieve, but if at least one screen with aperture size of from 75 μm (200 mesh) to 180 μm (80 mesh) is used in recovery, it will typically be a minimum of 2 mass %, preferably a minimum of 3 mass %, or preferably a minimum of 4 mass %. The maximum is approximately 10 mass %.

The product rate of heat treated fine PAS powder recovered as product is calculated as the entire amount of PAS obtained, based on the mass (theoretical amount) of PAS when it is assumed that all the effective sulfur component within the charged sulfur source present in the reaction vessel after the dehydration step has been converted into PAS. In other words, the product rate is the mass of heat treated fine PAS powder/mass of PAS (theoretical amount).

A high product rate of heat treated fine PAS powder indicates that raw material fine PAS powder, which was conventionally disposed of, can be reused from the separation liquid, offering excellent economic benefits.

The volume of generated gas in the heat treated fine PAS powder of the present invention depends on the screen aperture size of the sieve, but if at least one screen with aperture size of from 75 μm (200 mesh) to 180 μm (80 mesh) is used in recovery, it will typically be a maximum of 10 ppm, preferably a maximum of 8 ppm, more preferably a maximum of 5 ppm, and even more preferably a maximum of 4 ppm. The minimum value is 0 ppm, but typically it is approximately 0.05 ppm.

With this volume of generated gas, via the pre-heat treatment step, in other words, the accurate adjustment of thermal history, the generated gas is made easier to volatilize outside the fine powder; as a result, sufficient generated gas is volatilized via the heat treatment step.

The generated gas may include benzene compound containing sulfur, benzene compound containing halogen, halogenated compound containing nitrogen, organic compounds, substances with low boiling point containing sulfur, and the like.

The present invention provides a granular PAS manufactured via a manufacturing method including a polymerization step, wherein at least one sulfur source selected from the group consisting of an alkali metal sulfide and an alkali metal hydrosulfide and a dihalo aromatic compound are subjected to a polymerization reaction in organic amide solvent, and a separation step, wherein the reaction solution containing produced granular PAS is separated into granular PAS and separation liquid through solid-liquid separation, and a resin composition, including the heat treated fine PAS powder manufactured using the abovementioned method.

If the heat treated fine PAS powder is used as one component of the compound, on the basis of the total amount of granular PAS and heat treated fine PAS powder, the heat treated fine PAS powder may be included typically at a maximum of 10 mass %, preferably 8 mass %, and more preferably a maximum of 6 mass %, providing it does not damage the properties of the compound. From the point of view of economy, the minimum is approximately 1 mass %.

Being able to use raw material fine PAS powder, which was formerly disposed of, as a component of a compound having up to 10 mass % of the heat treated fine PAS power, based on the total amount of granular PAS and heat treated fine PAS powder, is extremely economically beneficial.

The average particle size of the granular PAS is typically from 130 to 1,500 μm, preferably from 150 to 1,500 μm, and more preferably from 180 to 1,500 μm.

### EXAMPLES

Below, the present invention is described in more detail using Manufacturing Examples, Working Examples, and Comparative Examples. The present invention is not limited by the following examples. In the following Working Examples and Comparative Examples, unless otherwise stated, “parts” and “%” are by mass.

Below, the measurement methods for each physical property are described.

(1) The Granular PAS Recovery Ratio and Fine PAS Powder Product Rate (mass %)

The granular PAS recovery ratio and heat treated fine PAS powder product rate are calculated as the entire amount of PAS obtained, based on the mass (theoretical amount) of PAS when it is assumed that all the effective sulfur component within the charged sulfur source present in the reaction vessel after the dehydration step has been converted into PAS.

In other words, the granular PAS recovery ratio is the mass of recovered granular PAS/mass of PAS (theoretical amount).

The product rate of heat treated fine PAS powder is the mass of productized heat treated fine PAS powder/mass of PAS (theoretical amount).

(2) Granular PAS Average Particle Size

The average particle size of the recovered granular PAS was measured using sieves of mesh #7 (aperture size 2,800 μm), #12 (aperture size 1,410 μm), #16 (aperture size 1,000 μm), #24 (aperture size 710 μm), #32 (aperture size 500 μm), #60 (aperture size 250 μm), #100 (aperture size 150 μm), #145 (aperture size 105 μm), and #200 (aperture size 75 μm).

(3) Raw Material Fine PAS Powder and Heat Treated fine PAS Powder Average Particle Size

The average particle size of raw material fine PAS powder and heat treated fine PAS powder were measured using a laser diffraction particles size distribution measuring device (SALD manufactured by Shimadzu Corporation).

(4) Weight Average Molecular Weight, and Peak Top Molecular Weight

The weight average molecular weight (Mw) of granular PAS, raw material fine PAS powder and heat treated fine PAS powder were measured using a high temperature gel permeation chromatograph (GPC) SSC-7101, manufactured by Senshu Scientific, Co., Ltd., under the following conditions. Weight average molecular weight, and peak top molecular weight are calculated using polystyrene as the standard.

Solvent: 1-chloronaphthalene,

Temperature: 210° C.,

Detector: UV detector (360 nm),

Quantity of sample inserted: 200 μl (concentration: 0.1 mass %),

Flow rate: 0.7 mL/min,

Standard polystyrene: Five types of standards polystyrene, 616,000, 113,000, 26,000, 8,200, and 600.

(5) Amount of Generated Gas

Generated gas was measured using the detector tube method.

Gas sampling set GASTEC GV-100S 1 minute retention

Gas detector tube

4.0 ppm or less: GASTEC No. 4LT

from 4 to 40 ppm: GASTEC No. 4LK

from 40 to 240 ppm: GASTEC No. 4L

Measurement Method

The dry block bath was heated to 280° C. (actual temperature) and the test tube set in place. Once it was confirmed that the test tube had heated to 280° C., a sample weighing 0.1000 g was inserted. After insertion, the test tube was quickly closed with a stopper with a gas insert tube and a gas output tube, and nitrogen gas was introduced at a flow rate of 16.67 mL/min. The gas discharged was collected in a Tedlar bag (1 L) for one hour, and measurement was performed using the abovementioned measuring device.

(6) Melt Viscosity

Approximately 20 g of dry product granular PAS, raw material fine PAS powder, and heat treated fine PAS powder was used to measure melt viscosity, using a Capillograph 1-C manufactured by Toyo Seiki Seisaku-sho, Ltd. A flat die having a diameter of 1 mm and length of 10 mm was used as the capillary, with the temperature set at 310° C. The abovementioned PAS specimens were inserted in the device and retained for 5 minutes, after which melt viscosity was measured at shear rate 1,216 sec⁻¹.

### PRODUCTION EXAMPLE

(Dehydration Step)

A 20 liter autoclave was used to hold 6,001 g NMP, 2,000 g sodium hydrosulfide aqueous solution (NaSH: purity 62 mass %), and 1,171 g sodium hydroxide (NaOH: purity 74.0 mass %).

After the inside of the autoclave was purged with nitrogen gas, it was stirred by a stirrer for 4 hours at a rotation speed of 250 rpm, while being heated gradually to 200° C., after which 1,014 g water (H₂O), 763 g NMP, and 12 g hydrogen sulfide (H₂S) were distilled away.

(Polymerization Step)

After the dehydration step the contents of the autoclave were cooled to 150° C., and 3.360 g pDCB, 2.707 g NMP, 19 g sodium hydroxide, and 167 g water were added, before heating to 220° C. and leaving to react for 5 hours to implement the first polymerization.

The ratio of NMP/charged sulfur source (hereinafter referred to as “preparation S”) within the vessel (g/mol) was 375, pDCB/preparation S (mol/mol) was 1.050, and H₂O/preparation S (mol/mol) was 1.50.

The pDCB conversion ratio after the first polymerization was 92%.

After the first polymerization was completed, the stir rotation speed was raised to 400 rpm, and 443 g ion-exchanged water was added to the autoclave while stirring. H₂O/preparation S (mol/mol) was 2.63. After the pressurized addition of ion-exchanged water, the temperature was raised to 255° C., and after 4 hours of reaction, the second polymerization was implemented.

(Separation Step)

After the second polymerization, the mixture was cooled to around room temperature, and the contents sieved using a screen with aperture size 150 μm (100 mesh), to obtain a wet cake of granular PPS on the sieve, and separation liquid below the sieve.

Subsequently, the granular PPS on the sieve was subjected to typical washing, drying and other recovery steps, and particle PPS for product was obtained with a recovery ratio of 88 mass %. The average particle size was 360 μm, the weight average molecular weight was 42,800, and the peak top molecular weight was 51,200.

### Working Example 1

The separation liquid obtained from under the sieve in the separation step in Working Example 1 was processed as below.

The separation liquid was filtered, to implement pre-solid-liquid separation and obtain raw material fine PPS powder and filtration liquid (pre-solid-liquid separation step). The raw material fine PPS powder was washed twice in acetone, and then filtered once again to separate it into raw material fine PPS powder and filtration liquid. The raw material fine PPS powder was dried using a dryer at 140° C. Next, washing was implemented using distilled water (byproduct alkali metal salt removal step), and solid-liquid separation was implemented using a filter press, obtaining a wet cake (solid-liquid separation step). Part of the wet cake obtained after solid-liquid separation was dried for 24 hours at room temperature, before its average particle size, weight average molecular weight, peak top molecular weight, and melt viscosity were measured.

Furthermore, the wet cake was washed (washing step). The washed wet cake was filtered using a filtration device. Next, the wet cake was dried for 3 hours at 60° C. under reduced pressure (90 KPa) as a pre-heat treatment step.

Next, the pre-heat treated raw material fine PPS powder that was pre-heat treated in the pre-heat treatment was heat treated for 3 hours at 220° C. in a nitrogen atmosphere as the heat treatment step, after which recovery was implemented to obtain a heat treated fine PPS powder. The results are shown in Table 1.

### Working Example 2

This was prepared in the same way as Working Example 1, except that the pre-heat treatment step was carried out under regular pressure conditions, at 140° C. for 3 hours. The results are shown in Table 1.

### Working Example 3

This was prepared in the same way as Working Example 1, except that the pre-heat treatment step was carried out under regular pressure conditions, at 120° C. for 3 hours. The results are shown in Table 1.

### Comparative Example 1

This was prepared in the same way as Working Example 1, except that no pre-heat treatment step was carried out, and a heat treatment step was carried out under regular pressure conditions, in a nitrogen atmosphere, at 220° C. for 6 hours. The results are shown in Table 1.

### Comparative Example 2

This was prepared in the same way as Working Example 1, except that the pre-heat treatment step was carried out under regular pressure conditions at 120° C. for 6 hours, and no heat treatment step was carried out. The results are shown in Table 1.

TABLE 1

| | | Working | Working | Working | Comparative | Comparative |
|---|---|---|---|---|---|---|
| | | Example 1 | Example 2 | Example 3 | Example 1 | Example 2 |
| Granular PPS | Weight average | 42,800 | 42,800 | 42,800 | 42,800 | 42,800 |
| (100 mesh on) | molecular weight | | | | | |
| | Peak top molecular | 51,200 | 51,200 | 51,200 | 51,200 | 51,200 |
| | weight | | | | | |
| | Melt viscosity (Pa · s) | 30 | 30 | 30 | 30 | 30 |
| | Average particle | 360 | 360 | 360 | 360 | 360 |
| | size (μm) | | | | | |
| | Recovery ratio (%) | 88 | 88 | 88 | 88 | 88 |
| Raw material | Weight average | 27,000 | 27,000 | 27,000 | 27,000 | 27,000 |
| fine PPS | molecular weight | | | | | |
| powder | Peak top molecular | 44,500 | 44,500 | 44,500 | 44,500 | 44,500 |
| | weight | | | | | |
| | Average particle | 10-15 | 10-15 | 10-15 | 10-15 | 10-15 |
| | size (μm) | | | | | |
| | Melt viscosity (Pa · s) | 2 | 2 | 2 | 2 | 2 |
| Pre-heat | Conditions | 60° C. | 140° C. | 120° C. | None | 120° C. |
| treatment step | | 3 hours | 3 hours | 3 hours | | 6 hours |
| | | Reduced | Regular | Regular | | Regular |
| | | pressure | pressure | pressure | | pressure |
| Heat | Conditions | 220° C. | 220° C. | 220° C. | 220° C. | None |
| treatment step | | 3 hours | 3 hours | 3 hours | 6 hours | |
| | | Nitrogen | Nitrogen | Nitrogen | Nitrogen | |
| | | atmosphere | atmosphere | atmosphere | atmosphere | |
| Heat treated | Average particle | 10-15 | 10-15 | 10-15 | 10-15 | 10-15 |
| fine PPS | size (μm) | | | | | |
| powder | Weight average | 41,800 | 42,500 | 41,000 | 40,100 | 27,800 |
| | molecular weight | | | | | |
| | Peak top molecular | 41,500 | 41,900 | 42,700 | 43,000 | 45,000 |
| | weight | | | | | |
| | Melt viscosity (Pa · s) | 20 | 23 | 22 | 14 | 3 |
| | Amount of | 2 | 2 | 2 | 12 | 68 |
| | generated gas (ppm) | | | | | |
| Product Rate | Product Rate | 4.8 | 5.1 | 5.1 | 5.2 | 5.1 |
| | (mass %) | | | | | |

### Working Example 4

A mixture of 60 mass % PPS, comprising 95 mass % of the granular PPS manufactured in the Production example and 5 mass % of the heat treated fine PPS powder manufactured in Working Example 1, along with 39.8 mass % fibrous filler (13 μm glass fiber) and 0.2 mass % mold releasing agent was combined for 5 minutes, after which it was melted and kneaded in a dual screw extruder with a cylinder temperature of 320° C. to form pellets. While the melted and kneaded pellets were being formed, no bad odor such as that seen in Comparative Example 3 described below was noted. 10 g of the pellets formed were measured into a 10 mm diameter test tube, and an SKD 11 metal piece measuring 8 mm square (2 mm thick) was placed on top of the accumulated pellets, before closing the tube with a silicone stopper. Subsequently, the test tube was placed in an aluminum block bath, and heated at 340° C. for 4 hours. When the volatile substance adhered to the metal piece was observed prior to and after the experiment, it looked the same as when no heat treated fine PPS powder had been added.

### Comparative Example 3

Except for using the fine PPS powder that was subjected only to pre-heat treatment in Comparative Example 2 in place of the heat treated fine PPS powder, the same process was implemented as that in Working Example 4. While pellets were being formed by melting and kneading, a terrible smell occurred. There was also a significant adhesion of volatile substances to the metal piece.

Observations

In Comparative Example 1, no pre-heat treatment was carried out, and heat treatment was implemented immediately in a nitrogen atmosphere at 220° C. for 6 hours. Since no pre-heat treatment was implemented, a significant quantity of gas was generated, and melt viscosity was low. Furthermore, despite the fact that the heat treatment time was twice as long as that in Working Examples, the melt viscosity was lower than that anticipated from the Working Examples. This suggests that if there is a large quantity of generated gas, melt viscosity is low.

In Comparative Example 2, pre-heat treatment was implemented at 120° C. for 6 hours, but no heat treatment was implemented. For that reason, there was a highly significant amount of generated gas from the pre-heat treated raw material fine PPS powder, while the weight average molecular weight and melt viscosity were low. In this case, despite the fact that the pre-heat treatment was implemented for a long time, no effect was noted.

Working Examples 1 to 3 were pre-heat treated, respectively, at 60° C. for 3 hours under reduced pressure; at 140° C. for 3 hours under regular pressure; and at 120° C. for 3 hours under regular pressure, after which each of them was heat treated at 220° C. for 3 hours. Because pre-heat treatment and then heat treatment were implemented in a state where the fine PPS powder thermal history had been accurately adjusted, impurities are well volatilized and there was little gas generated; furthermore, the heat treatment resulted in weight average molecular weight, melt viscosity and peak top molecular weight that were sufficient for practical use.

Furthermore, when the fine PPS powder from Comparative Example 3 and Comparative Example 2, which had not been subjected to heat treatment, were used in melted and kneaded pellets, a terrible smell occurred, and a significant quantity of volatile substances adhered to the metal piece. In comparison, in Working Example 4, when heat treated fine PPS powder was used as part of the compound, nothing adhered to the metal piece, indicating a high level of practical applicability.

### INDUSTRIAL APPLICABILITY

The heat treated fine PAS powder of the present invention can be reused as one component in a compound. The heat treated fine PAS powder of the present invention is manufactured from raw material fine PAS powder within the separation liquid that was conventionally disposed and not used, and it is extremely significant that it can now be reused without contaminating the work environment.

1. (canceled)

2. (canceled)

3. A manufacturing method for manufacturing a heat treated fine polyarylene sulfide powder, the manufacturing method comprising the following steps:
(a) a polymerization step, wherein at least one sulfur source selected from the group consisting of an alkali metal sulfide and an alkali metal hydrosulfide and a dihalo aromatic compound are subjected to a polymerization reaction in organic amide solvent;
(b) a separation step, wherein a reaction solution containing produced granular polyarylene sulfide is separated into the granular polyarylene sulfide and a separation liquid through solid-liquid separation;
(c) a solid-liquid separation step, wherein the separation liquid is subjected to solid-liquid separation to obtain a raw material fine powder polyarylene sulfide;
(d) a pre-heat treatment step, wherein the raw material fine powder polyarylene sulfide is preheated at from 50 to 150° C. to obtain a pre-heat treated raw material fine powder polyarylene sulfide; and
(e) a heat treatment step, wherein the pre-heat treated raw material fine powder polyarylene sulfide is heated at from 160 to 260° C. to obtain a heat treated fine powder polyarylene sulfide.

4. The manufacturing method according to claim 3, wherein the separation step is implemented using at least one screen with an aperture size in a range of 75 to 180 μm.

5. The manufacturing method according to claim 1, wherein the pre-heat treatment step is implemented under reduced pressure.

6. (canceled)

7. The manufacturing method according to claim 1, further comprising a washing step prior to the pre-heat treatment step, wherein the raw material fine powder polyarylene sulfide is washed using water, alcohol, acetone, acetic acid, acetic acid salt, hydrochloric acid, or a mixture thereof

8. The manufacturing method according to claim 1, wherein the heat treatment step is implemented in an inert gas atmosphere.

9. The manufacturing method according to claim 1, further comprising a pre-solid-liquid separation step and a byproduct alkali metal salt removal step prior to the solid-liquid separation step.

10. (canceled)

11. (canceled)

12. (canceled)
